(19) United States
(12) Patent Application Publication
(10) Pub. No.: US 2023/0262056 A1
(43) Pub. Date: Aug. 17, 2023

(54) Method of Managing User's Authentication Information

(71) Applicants: Daisuke NAGAYAMA, Tokyo (JP); Mukundu Kumaran, Santa Clara, CA (US); Rajkumar Madhuram, Milpitas, CA (US)

(72) Inventors: Daisuke NAGAYAMA, Tokyo (JP); Mukundu Kumaran, Santa Clara, CA (US); Rajkumar Madhuram, Milpitas, CA (US)

(21) Appl. No.: 18/160,199

(22) Filed: Jan. 26, 2023

Related U.S. Application Data
(60) Provisional application No. 63/303,258, filed on Jan. 26, 2022.

(51) Int. Cl. H04L 9/40

(52) U.S. Cl. CPC H04L 63/0861; H04L 63/102

(57) ABSTRACT

To provide a more efficient method of authentication. A method for managing identity authentication information via a web browser implemented in a user terminal connected to a server terminal via a network, wherein the server terminal receives, via the web browser implemented in the user terminal, input of identity authentication information of the user from the user; stores the identity authentication information; and upon receiving an access request for a desired website from the user via the web browser, provides information associated with the identity authentication information to an external service terminal operating the website.

### TECHNICAL FIELDS

This invention relates to a method of managing authentication information.

### BACKGROUND ART

In the past, users accessed the website of each service to use the service using a web browser such as Chrome (registered trademark), and then entered or uploaded authentication information such as name, address, contact information, credit card number, and other identification documents on the website.

Since it is time-consuming for a user who uses multiple services to verify his/her identity each time, technologies have been devised to provide an efficient method of authentication. For example, Patent Literature 1 provides a technology that stores the authentication data such as an image of an identification card in a virtual identification database and enables the authentication data used for one service provider to be used for other service providers.

### PRIOR ART LITERATURE

### Patent Literature

[PATENT LITERATURE 1] JP2021-082338A

### SUMMARY OF INVENTION

### Technical Problem

However, in the technology disclosed in Patent Literature 1, the user is required to send authentication data to the service provider each time he/she uses the service. In addition, in the case of conventional websites, the user is required to perform authentication at each website, and must provide authentication information each time, creating a security risk that authentication information may be leaked from one of the websites. It was also difficult for the user to keep track of which website he/she used to perform the authentication procedure.

Therefore, the purpose of this invention is to provide a more efficient method of authentication.

### Technical Solution

A method for managing authentication information via a web browser implemented in a user terminal connected via a network to a server terminal, in an aspect of the invention, wherein the server terminal receives, via a web browser implemented in the user terminal, input of authentication information from the user; wherein the server terminal stores the authentication information; and wherein, upon receiving, via the web browser, an access request from the user to an intended web site, the server terminal provides information associated with the authentication information to an external service terminal operating the web site.

### Advantageous Effect

According to this invention, it is possible to realize a more efficient method of authentication.

### BRIEF EXPLANATION OF DRAWINGS

FIG. 1 shows a block diagram of the first embodiment of this invention, showing the authentication system.

FIG. 2 shows a functional block diagram showing the server terminal 100 of FIG. 1.

FIG. 3 shows a functional block diagram showing the user terminal 200 of FIG. 1.

FIG. 4 shows an example of user data stored in the server 100.

FIG. 5 shows an example of authentication data stored on the server 100.

FIG. 6 shows an example of a flowchart for an authentication method in accordance with the first embodiment of this invention.

### DETAILED DESCRIPTION OF THE EMBODIMENTS

Embodiments of the invention will be described below with reference to the drawings. The embodiments described below do not unduly limit the contents of this disclosure as set forth in the claims. Not all of the components shown in the embodiments are essential components of this disclosure.

### Embodiment 1

### [Configuration]

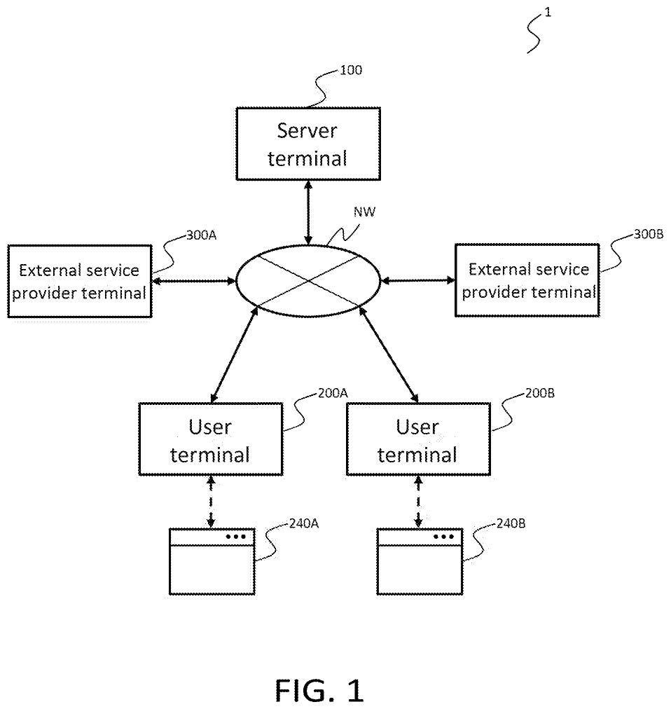

FIG. 1 is a block diagram showing the authentication of the first embodiment of this invention. In this system 1, a user who uses the services provided by each external service provider terminal 300A, 300B via websites provides authentication information through procedures such as eKYC to a server terminal 100 that manages authentication information via browsers 240A, 240B implemented in each of user terminals 200A, 200B. The server terminal 100 stores the authentication information provided by the user in association with the browser 240A, 240B. When a user accesses a website provided by external service provider terminals 300A and 300B via browsers 240A and 240B, the server terminal 100 shares the authentication information in response to a request by each external service provider terminal 300A and 300B to obtain authentication information.

Each of the server terminal 100, user terminals 200A and 200B, and external service provider terminals 300A and 300B are connected via a network NW. The network NW comprises the Internet, an intranet, a wireless LAN (Local Area Network) or WAN (Wide Area Network), etc.

The server terminal 100 is a device operated by the entity that manages authentication information, and may be a general-purpose computer such as a workstation or personal computer, or it may be logically realized by cloud computing. In this embodiment, one server terminal is shown as an example for convenience of explanation, but it is not limited to this and may be multiple.

User terminals 200A and 200B are devices used by a user who uses a service via a website provided by 300A and 300B to an external service provider terminal, and are information processing devices such as personal computers and tablet terminals, for example, but may also comprise smartphones, cell phones, PDAs, etc. User terminals 200A and 200B are equipped with browsers 240A and 240B, respectively, and the user accesses websites provided by external service provider terminals 300A and 300B via browsers 240A and 240B to use services provided by the respective service providers. The “browser” is assumed to be provided by the entity that manages the above authentication information, and may include a web browser, an application equivalent to a browser, or an application such as a metaverse application or the like.

External service provider terminals 300A and 300B are web servers, which are devices used by service providers that provide services via websites. Service providers include, for example, financial institutions, airline companies, game companies, advertiser companies, etc.

In this embodiment, the system 1 comprises the server terminal 100, user terminals 200A and 200B, and external service provider terminals 300A and 300B, and each user operates the server terminal 100 using the user terminals 200A and 200B and the external service provider terminals 300A and 300B. However, the server terminal 100 may be configured as a stand-alone terminal, and the server terminal itself may be equipped with a function for each user to operate the server terminal 100. For the convenience of explanation, user terminals 200A and 200B are collectively referred to as “user terminal 200,” and external service provider terminals 300A and 300B are collectively referred to as “external service provider terminal 300.

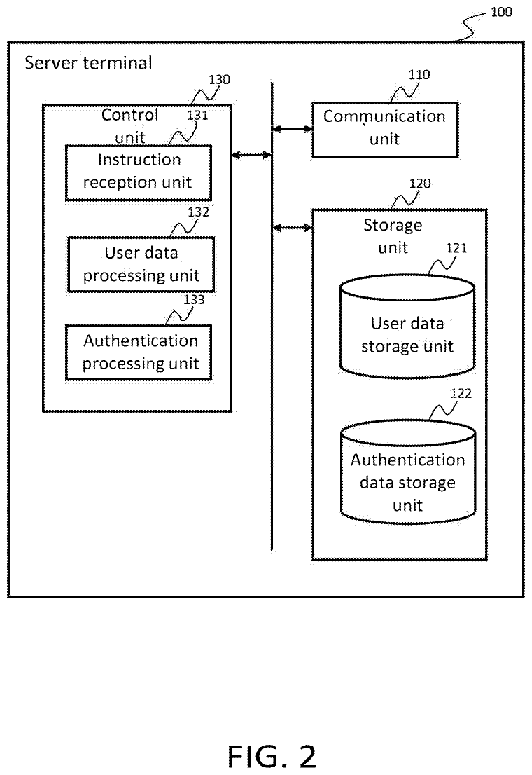

FIG. 2 is a functional block diagram of the server terminal 100 of FIG. 1. The server terminal 100 has a communication unit 110, a memory unit 120, and a control unit 130.

A communication unit 110 is a communication interface for communicating with the user terminal 200 and the external service provider terminal 300 via the network NW, for example, using communication conventions such as TCP/IP (Transmission Control Protocol/Internet Protocol).

A storage unit 120 stores programs for executing various control processes and functions in a control unit 130, input data, etc., and comprises RAM (Random Access Memory), ROM (Read Only Memory), etc. The storage unit 120 also has a user data storage unit 121 that stores various data related to the user, an authentication data storage unit 122 that stores various data related to the user's authentication, and the like. Furthermore, the storage unit 120 can also temporarily store data communicated with the user terminal 200. A database (not shown) storing various data may be constructed outside the storage unit 120 or the server terminal 100.

The control unit 130 controls the overall operation of the server terminal 100 by executing a program stored in the storage unit 120, and comprises a CPU (Central Processing Unit), GPU (Graphics Processing Unit), or the like. Functions of the control unit 130 include an instruction reception unit 131 that accepts input from the user terminal 200 or the external service provider terminal 300, a user data management unit 132 that references and processes various data related to the user, and an authentication processing unit 133 that performs processing related to the authentication of the user. The instruction reception unit 131, the user data management unit 132, and the authentication processing unit 133 are activated by a program stored in the storage unit 120 and executed by the server terminal 100, which is a computer (computer).

The instruction reception unit 131 accepts instructions from the user terminal 200 or the external service provider terminal 300 via the communication unit 110 when the user makes a predetermined input (by clicking, tapping, swiping, entering keywords, pressing an icon, etc.) via a user interface such as a screen provided by the server terminal 100 and displayed via a web browser or application at the user terminal 200 or the external service provider terminal 300.

The user data management unit 132 manages and processes various user-related data (e.g., identification information identifying the user (e.g., user ID, etc.), authentication data (image data of documents containing the user's name and address, e.g., driver's license, My Number card, insurance card, etc.), and biometric authentication data (e.g., vein authentication, fingerprint authentication, face authentication, etc. (in this example, it may not be through a browser), etc.).

An identity information processing unit 133 performs identity authentication processing based on the authentication information acquired from the user terminal 200, shares user data that has been processed for identity authentication upon request from the external service provider terminal 300, and performs other processing.

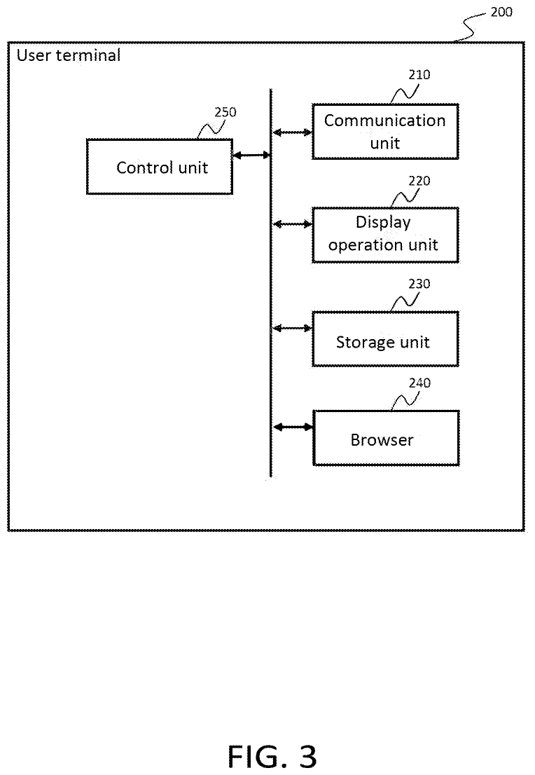

FIG. 3 is a functional block diagram showing the user terminal 200 of FIG. 1. The user terminal 200 has a communication unit 210, a display operation unit 220, a storage unit 230, a browser 240, and a control unit 250.

The communication unit 210 is a communication interface for communicating with the server terminal 100 via the network NW, for example, using communication protocols such as TCP/IP.

The display operation unit 220 is a user interface used by the user to input instructions and display text, images, etc. in response to input data from the control unit 250. When the user terminal 200 is configured as a personal computer, it consists of a display and a keyboard or mouse, and when the user terminal 200 is configured as a smartphone or tablet terminal, it consists of a touch panel or the like. The display operation unit 220 is activated by a control program stored in the storage unit 230 and executed by the user terminal 200, which is a computer (electronic calculation unit). Through the display operation unit, users can perform various input actions depending on the input device they are using. For example, with a keyboard, users can press keys; with a mouse, users can move the cursor; and with a touch panel, users can tap, swipe, pinch, and perform other touch-based actions.

The memory section 230 stores programs, input data, etc. for executing various control processes and each function within the control section 250, and comprises RAM, ROM, etc. The storage unit 230 also temporarily stores the contents of communication with the server terminal 100.

Browser 240 is software for displaying a website stored as a program in the storage unit 230 and displayed on the display operation unit 220, and the user can use the browser 240 to perform browsing and searching, or to access websites provided by the external service provider terminal 300.

The control unit 250 controls the overall operation of the user terminal 200 by executing a program stored in the storage unit 230, and comprises a CPU, GPU, or the like.

The server terminal 100 may be equipped with the function of the display operation unit, in which case it may be configured without the user terminal 200.

The functional block configuration of the external service provider terminal 300 can be substantially the same as that of the user terminal 200, and the explanation is omitted.

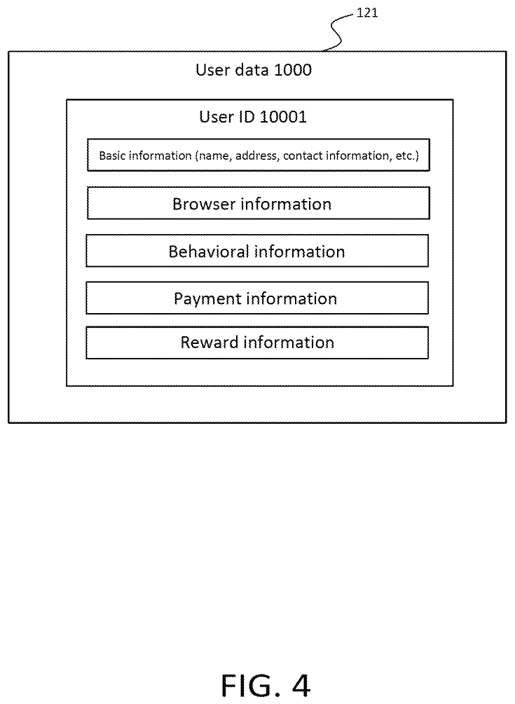

FIG. 4 shows an example of user data stored on the server 100.

User data 1000 shown in FIG. 4 stores various data related to a user. In FIG. 4, for convenience of explanation, an example of one user (the user identified by the user ID “10001”) is shown, but information on multiple users can be stored. Here, “user” includes, but is not limited to, users who use services via websites provided by 300A and 300B to external service provider terminals. Various data related to users include, for example, basic user information (e.g., name, address, contact information, etc.), browser information (e.g., identifier identifying the browser, etc.), behavioral information (e.g., history of websites accessed by the user, etc.), payment information (e.g., credit card information, bank account information, etc.)), and reward information (e.g., cash, points, frequent flyer miles, virtual currency, etc.) can be stored.

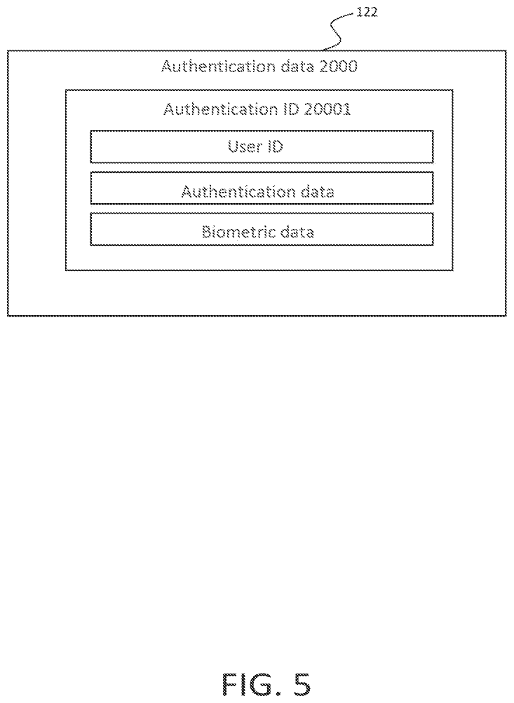

FIG. 5 shows an example of authentication data stored on the server 100.

The authentication data 2000 shown in FIG. 5 stores various types of data related to the user's authentication. In FIG. 5, for convenience of explanation, an example of one user's authentication information (data identified by the authentication ID “20001”) is shown, but authentication information for multiple users can be stored. Various types of data related to identity verification include, for example, authentication information that identifies the user (e.g., user ID, etc.), authentication data (documents containing the user's name and address, e.g., driver's license, My number card, insurance card, etc.), and biometric authentication data (e.g., vein authentication, fingerprint authentication, facial recognition, etc.) (in this example, the data may not be transmitted through a browser)).

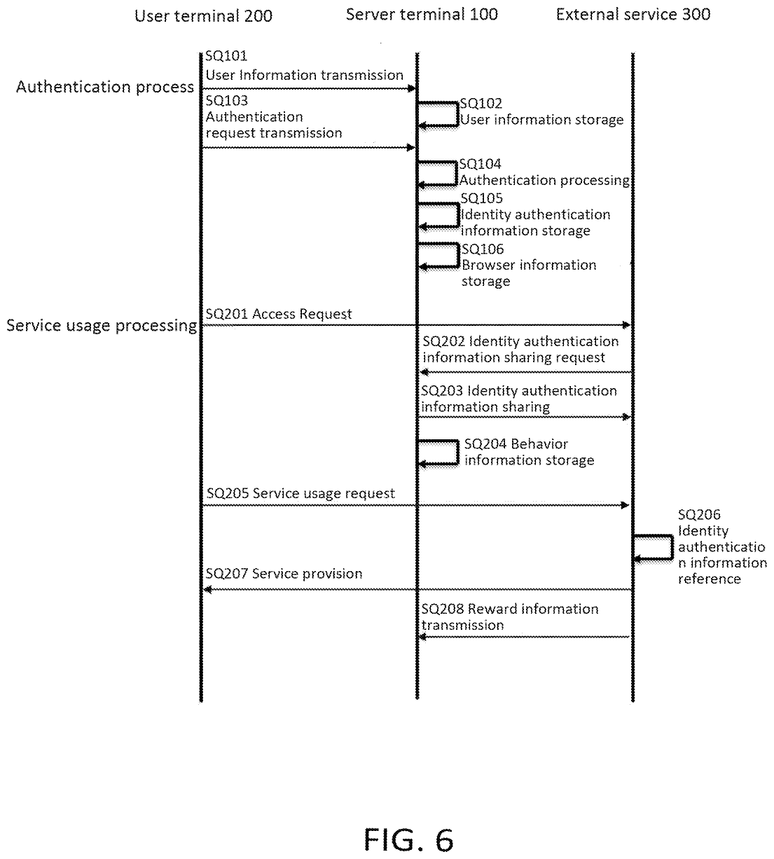

FIG. 6 is an example of a flowchart for a method of authentication, in accordance with the first embodiment of this invention.

Here, in order to use this system 1, browser 240 provided by the entity in this embodiment is installed in the user terminal 200, and the user starts the browser 240 and performs the registration of user information and authentication procedures through the browser 240.

Here, as SQ101, the user inputs user information (e.g., basic information (e.g., name, address, contact information, etc.)) via the browser 240 and sends it to the server terminal 100. As SQ102, the server terminal 100 stores the received user information in the user data storage unit 121 of the storage unit 120.

Then, as SQ103, the user sends authentication information (an image of a document containing the user's name and address, e.g., driver's license, My number card, insurance card, etc.) and/or biometric authentication information (e.g., vein authentication, fingerprint authentication, facial recognition, etc. (in this example, this may not be done via a browser)) to the server terminal 100 via browser 240 through eKYC or other procedures as a procedure to confirm the identity of the user. Here, the user may also perform procedures such as eKYC through other applications provided by the server terminal 100, without going through the web browser 240. Here, by managing biometric authentication information, a two-step authentication of biometrics can be applied in addition to the usual authentication information, depending on the nature of the content viewing or transactions that affect minors, such as parental control.

As SQ104, the server terminal 100 executes the user's identity verification process (authentication process) based on the received user's identity verification information, and as SQ105, stores the identity verification information as identity verification data in the authentication data storage unit 122 of the storage unit 120. As described above, if the user has performed the identity authentication procedure in advance, the server terminal 100 can also store the user's authentication information in the storage 120 in advance.

Next, as SQ106, the server terminal 100 stores an identifier (e.g., browser ID) identifying the browser 240 installed on the user terminal 100 in the user data storage unit 121 of the storage unit 120, either in advance or upon receiving the user information or authentication information. In this way, the server terminal 100 stores the browser information identifying the web browser 240 and the authentication information confirming the user's identity along with the user identifier (user ID) for each user, so that the authentication information can be managed in connection with the web browser used by the user. If the user has already completed the identity authentication procedure through another entity, the server terminal 100 can also retrieve the identity authentication information from the server terminal of that entity through cooperation with other entities (for example, but not limited to, financial institutions).

Next, as SQ201, in order to use the desired service, the user starts the web browser 240 and accesses the website provided by the external service provider terminal 300 operated by the service provider by browsing or searching, etc. via the web browser 240. As SQ202, the server terminal 100 receives a request for sharing identity authentication information from the external service provider terminal 300 that operates the website, triggered by the user's access request to the website. Here, a request to share identity authentication information includes a request to share a user ID that is managed in association with the identity authentication information. As SQ203, the server terminal 100 sends the user ID to the external service provider terminal 300 to share the identity authentication information.

Here, in connection with the above browsing, if the application implemented in the user terminal is a metaverse application, the user may also browse in the metaverse or virtual reality space by moving as a user avatar and visiting desired locations in the metaverse or virtual reality space. As another example, if the application is a map application, the user may browse by moving in real space, sending the user's location information to the server terminal, and visiting the desired location. As described above, since the web browser and identity information are managed in association with the web browser, the server terminal can share identity authentication information via the user ID to the website of the service provider accessed above.

Here, the user may set in advance to allow the sharing of identity authentication information to a predetermined website, and by storing the permission/denial permission settings along with the website URL in the server terminal 100, the user can also manage the scope of sharing of identity authentication information. Alternatively, the server terminal 100 can link and manage service user IDs for services provided by the external service provider terminal 300 and user IDs stored as user data in the storage unit 120. When the user enters the service user ID via the browser 240 and logs into a given service, the server terminal 100 can also share the user ID with the server terminal of that service if the user ID is tied and managed.

In addition, the user may share identity authentication information regarding the information he/she provides to service providers (including but not limited to name, address, contact information, credit card number, etc.), but the user may also share temporary information (i.e., alternative personal name, address, etc., or virtual name, address, etc., or encrypted name, address, etc., or theoretically, various other temporary information) to keep his/her true personal information confidential). For example, suppose that an e-commerce company and a delivery company are service providers. In this case, the delivery service provider needs to know the user's real address, but the e-commerce service provider does not need to know the real address. Therefore, when the encrypted name and address are shared with the e-commerce business operator and the decryption method is also shared with the delivery business operator, only the delivery business operator can know the user's true name and address and use them for delivery. In this way, in sharing identity authentication information, a mechanism can be provided for each service provider to limit the sharing to the minimum necessary for the user's purposes.

Then, as SQ204, the server terminal 100 can also store the fact that the identity authentication information was shared with the external service provider terminal 300 as behavioral information user data in the user data storage unit 121 of the storage unit 120. This allows the server terminal 100 to manage the browsing history of the user's access to the website without relying on cookies.

As SQ205, the user terminal 100 then sends a request to the external service provider terminal 300 to use the desired service on the accessed website. The service use request includes, but is not limited to, requests to purchase products, view content, post content, or conduct other transactions of goods or money provided via the website provided by the external service provider terminal 300.

In response to the service use request by the user, the external service provider terminal 300 confirms that the authentication process has been performed in advance by referring to the user ID shared in advance from the server terminal 100 as the process in SQ206. Here, the external service provider terminal 300 can also manage the service user ID of the service provided by the service provider concerned by linking the shared user ID. When a user enters the service user ID via the browser 240 and logs into a given service, if the user ID is tied and managed, it can be determined that authentication is being performed. Then, as SQ207, the external service provider terminal 300 provides the requested service to the user terminal 100. This allows the user to use services such as payment processing without having to go through the authentication process again in order to use the service on the website to be accessed.

Here, as SQ208, the user agrees to share the user ID associated with the identity authentication information with other website operators, or fulfills other conditions such as browsing the website or its contents or performing various actions on the website as part of the service use. By doing so, the user may receive legal tender, points, mileage, virtual currency, or other rewards that are returned for sharing identity authentication information, and in such cases, the server terminal 100 stores the reward information received from the external service provider terminal 300 in the user data storage unit 121 of the storage unit 120.

In addition, by implementing payment applications, insurance applications, and other programs via APIs or other means in web browser 240, users can use services provided by other websites to make payments via payment programs or other means implemented in the web browser.

In addition, a link for web advertising is embedded in the website displayed on the web browser 240. When the user selects the link for the web advertisement by clicking or otherwise selecting it, if the operator providing the web advertisement and the operator operating the server terminal 100 have agreed in advance to share user IDs and to cooperate with each other's web sites, the user can access the server terminal 100 and process the display of web advertising content stored on that server without having to access the operator server that provides the web advertising. In the same way, content other than web advertisements and recommended products can be displayed based on user behavior information and assumptions of interests and preferences.

In addition, the browser 240 can be made available as a so-called super-application, with the ability to integrate multiple applications. For example, by equipping the browser 240 with a messaging function, the user of the browser 240 can communicate with other users, assuming that authentication has been performed. Also, by providing a voting function, the user can vote online, assuming that authentication has been performed. Furthermore, by providing an electronic signature function, electronic signature procedures that were previously performed via an e-mail address that could not be uniquely linked to the user can be performed via a browser that has already performed authentication, and electronic signatures can be performed in a manner that guarantees the authentication of the user.

As described above, users can access each website through the browser that has undergone the identity authentication process in advance, allowing them to use the service without having to go through the identity authentication process each time they visit the website. The service provider can provide services to users in a secure manner without having to record and manage identification information.

The above described embodiments of the disclosure can be implemented in various other forms, and can be implemented with various omissions, substitutions, and modifications. These embodiments and variations, as well as omissions, substitutions, and modifications, are included within the technical scope of the claims and their equivalents.

### DESCRIPTION OF REFERENCE NUMERALS

1 System
100 Server terminal
110 Communication unit
120 Storage unit
130 Control unit
200 User terminal
300 External service provider terminal
NW Network

1. A method for managing identity authentication information via a web browser implemented in a user terminal connected via a network to a server terminal,
wherein the server terminal receives, via the web browser implemented in the user terminal, input of identity authentication information from the user; stores the identity authentication information;
and, upon receiving, via said web browser, an access request from the user to a desired web site, provides information associated with the identity authentication information to an external service terminal operating the website.

2. The method according to claim 1,
wherein the identity authentication information includes image data of either a driver's license, a personal number card, or an insurance card.

3. The method according to claim 1,
wherein the server terminal stores the identity authentication information in association with the identification information that identifies the user.

4. The method according to claim 1,
wherein the server terminal stores the identity authentication information in association with the identification information identifying the web browser.

5. The method according to claim 1,
wherein the server terminal receives identification information identifying the user from the external service terminal and transmits the identity authentication information stored in association with the identification information to the external service terminal.
